(19) United States
(12) Patent Application Publication
(10) Pub. No.: US 2026/0240095 A1
(43) Pub. Date: Aug. 20, 2026

(54) MODULAR SYSTEM FOR CULTIVATION

(71) Applicant: THE HOUSE FARMER S.R.L., MILANO (IT)

(72) Inventor: Giudo Carlo Parazzoli, Milano (IT)

(21) Appl. No.: 19/469,511

(22) PCT Filed: Mar. 13, 2024
(86) PCT No.: PCT/IB2024/052412

§ 371 Date: Sep. 26, 2025

(30) Foreign Application Priority Data
Mar. 29, 2023 (IT) 102023000006057

(51) Int. Cl. A01G 27/00

(52) U.S. Cl. CPC A01G 27/005; A01G 27/003

(57) ABSTRACT

The invention relates to a modular system (10) for cultivation in an urban environment comprising at least one cultivation pot (100, 200), said pot (100, 200) being provided with a plurality of environmental sensors, a water reservoir (72) feeding an irrigation circuit. The pot (100, 200) is associated with an electronic card (450) configured to receive data from the sensors and to impart commands to a pump (22) immersed in the reservoir (72), wherein the pump allows irrigation according to predetermined work programs and is electrically powered. The electronic card (450) is configured to communicate in low frequency with other remote cultivation pots equipped with similar electronic cards. The connection between pots can be in the form of a mesh network.

### FIELD OF THE INVENTION

The present invention relates to a modular system for cultivation, preferably in an urban environment.

### PRIOR ART

It is estimated that there are more than 10 million terrace or balcony cultivators in Europe with an increasing trend.

On a cultural level, awareness towards the environment and what we eat is growing.

Worldwide, there is already a movement involving more and more city dwellers, who want to bring nature and plants into their living environment and demand real urban pleasure gardens or even urban farming facilities on their balcony, terrace or roof terrace.

The creation of real gardens or agricultural structures on balconies, terraces or roof terraces requires landscape architects to provide modular containers that can be adapted to any type of space, that are aesthetic, inexpensive and always lighter to favour plants and their substrate with respect to the containers.

At present, however, containers or pots for cultivation are generally passive and do not allow complete interaction with the user.

Document US 2022/369566 describes an indoor gardening apparatus comprising a plant support frame defining a plurality of openings to support one or more plant containers above a reservoir for collecting excess water. A pump recirculates the water from the collection reservoir to the plant support frame, where it is distributed to the plants via distribution channels. A light assembly is positioned above the plant support frame and selectively illuminates the plant support frame based on ambient lighting conditions measured by a light sensor. A controller may include a communication module or interface that may be used to communicate with one or more other components of the device itself or with an external controller of the device to manage the pot itself.

Document US 2019/0113495 describes an apparatus and method for remotely controlling and monitoring plant growth that is provided with an apparatus for monitoring the growth of various plants. The method sets out the steps for operating the apparatus. A plant container and an irrigation system for watering the plants are provided.

A plurality of sensors are provided to monitor the environmental conditions of the plants and to alert the user if any parameter is outside an acceptable range, and at least one camera is provided to view the plant at any time and to capture images and timelapses thereof.

Document WO 2007/078235 describes a plant container comprising a pot part and a lid part. The plant pot includes a climate controller and heat transfer means connected thereto for controlling the temperature in the plant pot in response to at least one climate parameter. The cover part is movable between a first position for storage and a second position for plant protection. The plant pot also has a storage space for the cover part when it assumes the first position.

Document US 2017/0094912 describes a portable planter suitable for use in both a commercial and residential environment, with easy access and internal irrigation. The portable planter is suitable for use in a minimal space and for being moved from one space to another. The planter is uniquely designed to allow stacking and can be folded for easy storage and transport to multiple locations.

An object of the present invention is thus to create a modular system for cultivation, preferably in an urban environment, which allows a user to control their cultivation even remotely.

A further scope of the present invention is to create a modular cultivation system that allows a community to manage its own cultivation project in a dynamic, innovative and integrated manner.

Not last of the purposes of the invention is to achieve the above-mentioned results in a practical and efficient manner.

### SUMMARY OF THE INVENTION

The above-mentioned purposes are obtained by virtue of a modular system for cultivation preferably in urban environment, wherein said system comprises at least one cultivation pot, said pot being provided with a plurality of environmental sensors, a water tank which feeds an irrigation circuit, said pot being able to be combined with an electronic card configured to receive data from said sensors and to impart commands to a submersible pump in the tank, wherein said pump allows the irrigation according to pre-set irrigation programmes and wherein said pump can be electrically powered, characterized in that said electronic card is configured to communicate in low frequency with other remote cultivation pots equipped with similar electronic cards.

An advantage of this embodiment is that it allows one to manage one's cultivation remotely and automatically.

The term low frequency in the context of the present description means, in particular, the frequencies used by LoRa technology.

According to an embodiment of the invention, the electronic cards of a plurality of cultivation pots can be interconnected to form a mesh network.

Several advantages are thus achieved.

Firstly, the low-frequency mesh network can cover a larger area, overcoming physical obstacles and greater distances than a traditional wireless network.

Furthermore, the reliability of the system is increased: if a node in the network fails or loses connection, data can be redirected through other nodes, ensuring continuity in data collection and transmission.

Furthermore, adding new pots to the network is simple, as each new pot can be configured to automatically join the existing network, thus creating the premises and infrastructure for building a large community.

Finally, mesh networks are often designed to be energy efficient, which is particularly useful in this application where the pots may be predominantly outdoor.

Further features of the invention may be deduced from the dependent claims.

### BRIEF DESCRIPTION OF THE FIGURES

Further features and advantages of the invention will be apparent from reading the following description provided by way of non-limitative example, with the aid of the illustrated figures in the appended tables, in which:

FIG. 1 is an illustrative diagram of the system of the invention;

FIG. 2 illustrates a top view of a portion of a first embodiment of the pot pertaining to the invention;

FIG. 3 illustrates a perspective view of a portion of a first embodiment of the pot according to the present invention without a flexible cover element.

FIG. 4 illustrates an exploded view of a portion of a first embodiment of the pot according to the present invention without a flexible cover element;

FIGS. 5a, 5b illustrate two views, in perspective and from above, respectively, of a first embodiment of the pot according to the present invention, with the flexible covering element fitted.

FIG. 6 illustrates a perspective view of a second embodiment of a pot according to the invention.

### DETAILED DESCRIPTION OF THE FIGURES

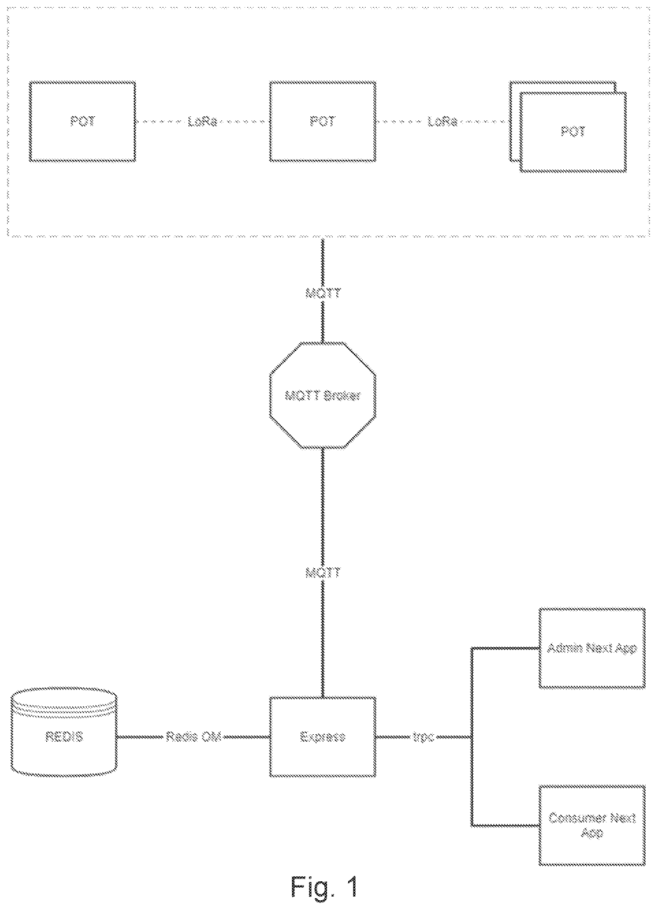

The invention will now be described with particular reference to the appended figures, wherein in particular, FIG. 1 illustrates a schematic of the system of the invention, said system being globally indicated by the numerical reference 10.

As illustrated above, the modular system 10 for cultivation in an urban environment comprises at least one cultivation pot 100, 200.

The pot 100, 200 is provided with a plurality of environmental sensors and a water reservoir 72 feeding an irrigation circuit.

The pot 100, 200 is associated with an electronic card 450 configured to receive data from the sensors and to impart commands to a pump 22 immersed in the reservoir 72, wherein said pump 22 enables irrigation according to predetermined work programs.

The pump 22 is electrically powered. Preferably via battery.

The battery or directly the pump 22 can be powered via a photovoltaic panel.

The electronic card 450 and the immersion pump 22 are contained within a special compartment.

The water tank 72 takes the form of a box shape comprising a base 74 and a removable lid 73.

The removable lid 73 may include special slots 75 configured to drain excess irrigation water within the tank.

As illustrated in FIG. 1, the pot 100,200 is connected to the outside world for example, but not exclusively, via LoRa technology.

For example, several pots can be connected to each other via said technology.

More specifically, the electronic card 450 of a pot is configured to communicate in low frequency with other remote cultivation pots equipped with similar electronic cards.

Of course, other known connection technologies such as Wi-Fi and Bluetooth can also be used as an alternative.

As mentioned above, low frequency in the context of this description means the frequencies used by LoRa technology.

For example, LoRa uses free sub-gigahertz radio frequency bands such as 433 MHz, 868 MHz (Europe) and 915 MHz (North America).

The low frequency allows for long-range communication, is suitable for community building and allows the pot to be placed anywhere, not necessarily indoors, but also outdoors, the pots not necessarily being connected to a cable or wireless.

If messages need to be translated from the sender's formal messaging protocol to the receiver's formal messaging protocol, a message broker, e.g. but not exclusively the MQTT protocol, can be used, as shown in FIG. 1.

A distributed database, e.g., but not exclusively, REDIS, may be used to manage external apps, either by the system administrator or by clients.

According to an embodiment of the invention, the electronic cards of a plurality of cultivation pots can be connected to form a mesh network, which is, as it is known, a type of wireless network in which the various nodes work together to distribute the signal over a larger area than could be covered by a single access point.

Through the dedicated mesh network, each node captures and transmits its own data and serves as a gateway for other nodes, thus configuring a network completely dedicated to the management of potted crops. The advantage of the mesh network is the possibility to position and control a pot even at different distances and in the absence of Wi-Fi.

Preferably each node should be within a distance of 15 km from another node.

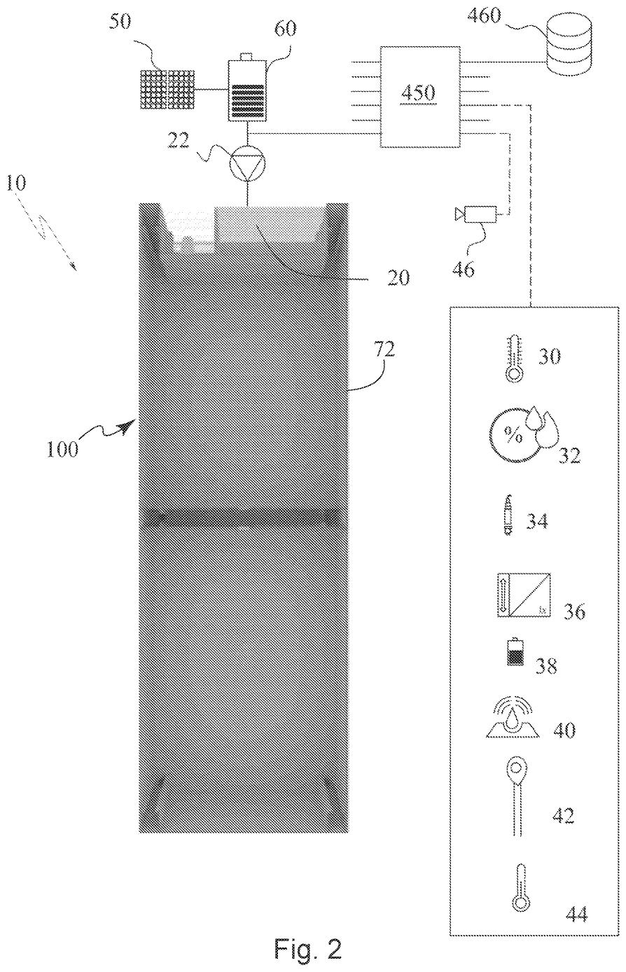

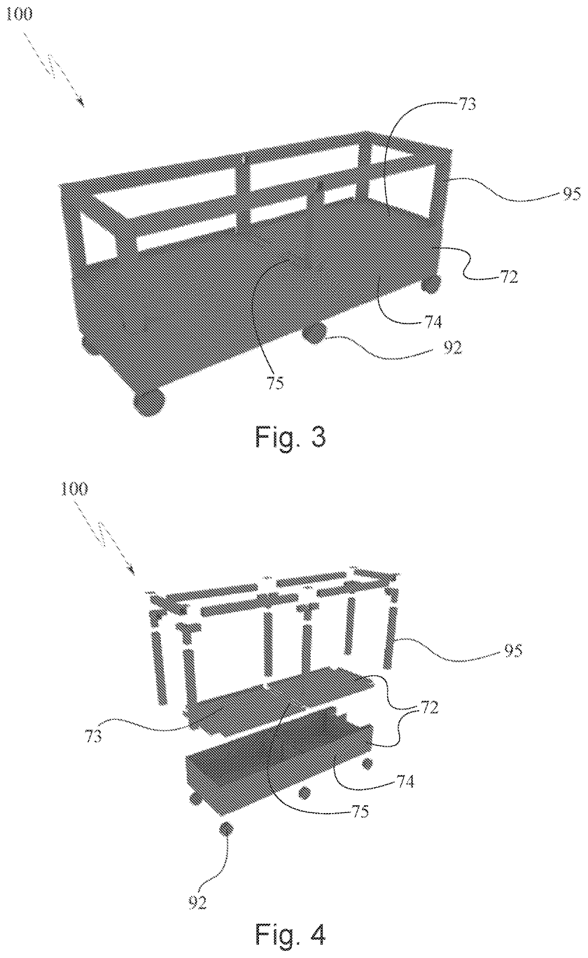

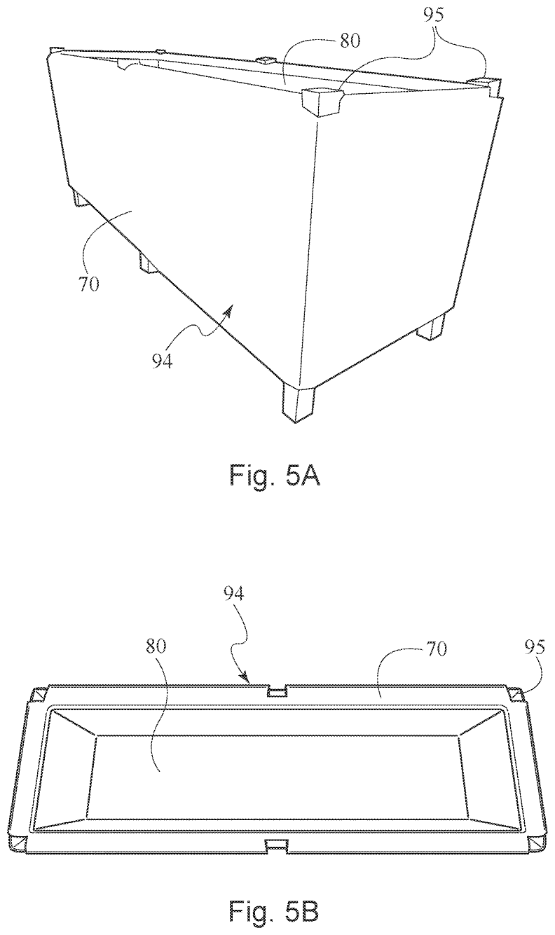

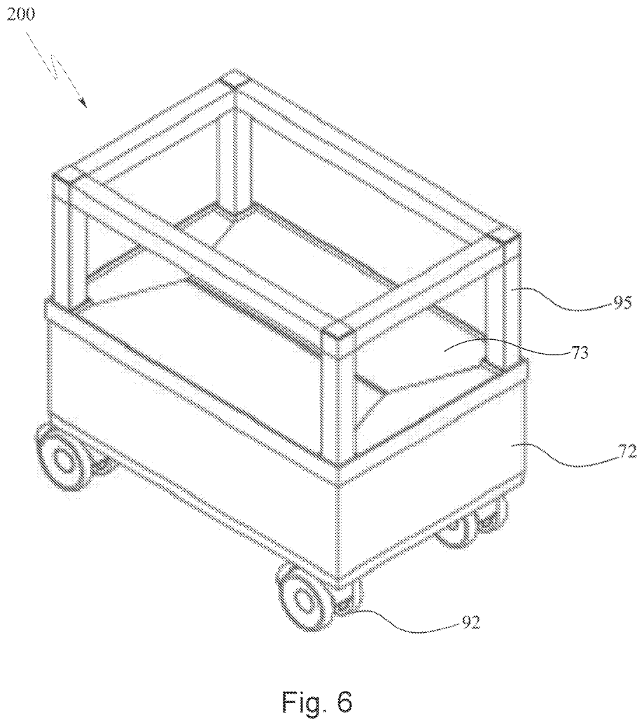

As also visible in FIG. 2, environmental sensors applicable to the cultivation pot 100, 200 may comprise temperature sensors 30, humidity sensors 32, PM2.5 sensors 34, ambient light sensors 36, battery charge status 38, water level 40 in the reservoir 72, soil PH level 42, plant health status and air quality sensors 44.

The electronic card 450 may comprise a memory unit 460 for operating software for said card and may be associated with a single pot 100, 200 for controlling the functionality of said pot or may serve as an electronic hub for controlling the functionality of a plurality of pots in a community.

The electronic card 450 applied to said pot 100, 200 can be integrated with a software application for mobile devices to manage the functionality of the pot 100, 200 remotely, and with a web platform to profile the individual pot or individual user with protected access.

Said application includes a system for recognizing geographic cardinal directions (North, South, East, West) as an aid to positioning the pot and is integrated with the sensors positioned in the 100, 200 pot to ensure crop control.

Said application can also be connected with the cloud platform (webapp) from which it receives information that the platform in turn receives from the sensors positioned in the individual pot.

In addition, said application can be associated with a video camera 46 for streaming footage and can provide a user with push notifications regarding the remote control of the pot, as well as information that is available on the move and that is perfectly adapted to the situation of the pot crop, and provide academies, tips and videos for learning how to grow.

The pot 100, 200 according to the present invention includes a support skeleton 95 and a flexible cover element 94 configured to be shod on the support skeleton 95 and to hold the growing medium.

The flexible covering element 94 takes the form of a bag to be shod on the supporting skeleton 95, so as to contain the soil and thus the crop to be cultivated.

In the embodiment shown in the figures, the flexible cover element 94 comprises an outer cover 70 configured to resist weathering and an inner cover 80 permeable to water.

The outer cover 70 and the inner cover 80 are solidly coupled, either by stitching or by other fastening systems.

The outer cover 70 and the inner cover 80 are both washable, and made of recycled materials.

Preferably, the outer cover 70 is made of a material resistant to ultraviolet (UV) rays, and to temperature changes.

Preferably, the inner cover 80 has at least one base made of non-woven fabric so as to allow excess water to pass through to be collected by a reservoir below 74 in an internal collection system that allows water recovery.

Preferably, the outer cover 70 is made of plastic collected from the seas and recycled.

On the other hand, the supporting skeleton 95 is preferably made from spent sock nylon.

The support skeleton 95 is made from a plurality of tubular elements that can be associated together to form a support structure extending from the reservoir 72 to the flexible cover element 94.

The flexible cover element 94 may comprise removably attachable means for enabling it to be removably attached to the skeleton 95.

In a preferred embodiment, said pot 100,200 is provided with wheels 92 for easy and convenient movement.

The system also allows the activation of a portal on which it is possible to profile both to purchase and to control the pot, as well as to perform software updates for individual pots.

Specialized operators can eventually use this portal to access the individual pot and restart the system in the event of an error/failure.

Of course, the invention as described may be modified or improved for contingent or particular reasons, without departing from the scope of the invention.

1. Modular system (10) for cultivation preferably in urban environment, wherein said system comprises at least one cultivation pot (100,200), said pot (100,200) being provided with a plurality of environmental sensors, a water tank (72) which feeds an irrigation circuit, said pot (100,200) being able to be combined with an electronic card (450) configured to receive data from said sensors and to impart commands to a submersible pump (22) in the tank (72), wherein said pump allows the irrigation according to pre-set irrigation programmes and wherein said pump (22) can be electrically powered, characterized in that said electronic card (450) is configured to communicate in low frequency with other remote cultivation pots equipped with similar electronic cards.

2. Modular system (10) for cultivation according to claim 1, in which the electronic cards of a plurality of cultivation pots can be interconnected to form a mesh network.

3. Modular system (10) for cultivation according to claim 1, wherein the sensors applicable to the cultivation pot (100,200) comprise at least one sensor selected from: sensors of temperature (30), humidity (32), PM2.5 (34), ambient light (36), battery charge status (38), water level (40) in the tank (20), water pH (42), plant health status and air quality (44).

4. Modular system (10) for cultivation according to claim 1, wherein the electronic card (450) is combined with a single pot (100,200) for controlling the functionalities of such pot and/or can serve as electronic hub for sorting data from and to the cloud for controlling the functionalities of a plurality of pots in a community.

5. Modular system (10) for cultivation according to claim 1, wherein the electronic card (450) applied to said pot (100,200) can be integrated with a software application for mobile devices to remotely manage the pot functionalities (100,200) with a web platform that allows to profile the single pot and/or the single user.

6. Modular system (10) for cultivation according to claim 5, wherein said application provides for a system for recognizing geographical cardinal directions as an aid to positioning the pot (100,200) and is integrated with the sensors positioned in the pot (100,200) to ensure culture control.

7. Modular system (10) for cultivation according to claim 5, wherein said application can be combined with a video camera for streaming footage and can provide a user with push information that relates to remote control of the pot (100,200), as well as information that is available on the move and that is perfectly matching the situation of the pot culture, as well as can provide Academy, tips and videos to learn to cultivate.

8. Modular system (10) for cultivation according to claim 1, wherein said pot (100,200) provides a supporting skeleton (95) and a flexible covering element (94) configured to be fitted on said supporting skeleton (95) and to contain the cultivated soil.

9. Modular system (10) for cultivation according to claim 8, wherein said flexible covering element (94) comprises an outer cover (70) configured to resist atmospheric agents and an inner cover (80) permeable to water, said outer cover (70) and said inner cover (80) being integrally coupled.

10. Modular system (10) for cultivation according to claim 8, wherein said flexible covering element (94) is removably combined with respect to said supporting skeleton (95) so that it can be replaced.

11. Modular system (10) for cultivation according to claim 8, wherein said pot (100,200) comprises a power supply battery (60).

12. (canceled)
